(19) United States
(12) Patent Application Publication
(10) Pub. No.: US 2025/0026221 A1
(43) Pub. Date: Jan. 23, 2025

(54) VEHICLE CHARGING SYSTEM

(71) Applicant: Transportation IP Holdings, LLC, Norwalk, CT (US)

(72) Inventors: Rob Alton, Erie, PA (US); Jeremy Thomas McGarry, Erie, PA (US); Ajith Kuttannair Kumar, Erie, PA (US)

(21) Appl. No.: 18/596,174

(22) Filed: Mar. 5, 2024

Related U.S. Application Data
(60) Provisional application No. 63/514,677, filed on Jul. 20, 2023.

(51) Int. Cl. B60L 53/60; B60L 53/16; B60L 53/20; H02J 7/00; H02J 7/04; H02J 7/34

(52) U.S. Cl. CPC B60L 53/60; B60L 53/16; B60L 53/20; H02J 7/0063; H02J 7/04; H02J 7/342; B60L 2200/26; B60L 2210/10; B60L 2210/30; H02J 2207/20

(57) ABSTRACT

A power supply system can exchange electricity with a vehicle. The power supply system may include a first circuit rated at a lower first voltage that can provide the electricity to a starter battery and/or an auxiliary load onboard the vehicle. The system also can include a second circuit rated at a higher second voltage and that can provide the electricity to a propulsion battery capable of powering one or more traction motors of the vehicle.

### CROSS-REFERENCE TO RELATED APPLICATIONS

This application claims priority to U.S. Provisional Application No. 63/514,677 (filed 20 Jul. 2023), the entire disclosure of which is incorporated herein by reference.

### BACKGROUND

### Technical Field

The subject matter described herein relates to a system and method for charging a vehicle system formed from a single vehicle or multiple vehicles.

### Discussion of Art

Some known vehicle charging systems are limited by the need to supply current at a fixed frequency due to the circuitry onboard vehicles being unable to accept alternating currents (AC) of different frequencies. Additionally, some of these vehicles may have starter batteries that operate to start engines of the vehicles and separate propulsion batteries that operate to power motors for moving the vehicles. Further, some vehicles may have auxiliary systems that power various hotel loads and may operate at voltages closer to the starter batteries than to the higher-voltage propulsion batteries. But charging systems may be limited to charging the propulsion batteries and are not able to charge the starter batteries owing to incompatibilities in the systems. Some incompatibilities may include voltage differences in which propulsion voltages may damage or destroy starter batteries/aux batteries. Other incompatibilities may include differences in frequencies. Yet other incompatibilities may result from a lack of communication capabilities between the vehicle and the charger with respect to the starter battery and/or aux systems. It may be desirable to have a system and method that differs from those that are currently available.

### BRIEF DESCRIPTION

In one example, a power supply system can exchange electricity with a vehicle. The power supply system may include a first circuit rated at a lower first voltage that can provide the electricity to a starter battery and/or an auxiliary load onboard the vehicle. The system also can include a second circuit rated at a higher second voltage and that can provide the electricity to a propulsion battery capable of powering one or more traction motors of the vehicle.

In another example, a power supply system may receive electricity supplied to a vehicle. The power supply system can include a first circuit and a second circuit each coupled to an alternating current bus, and a plurality of power converter and battery pairs. Each of the power converters can be coupled to the alternating current bus and may convert alternating current from the alternating current bus to direct current and to supply the direct current to the respective battery.

In another example, a charging system may supply electricity to a vehicle. The charging system can include connectors that may mate or couple with corresponding first and second vehicle connectors, a continuity circuit that can mate or couple third and fourth vehicle connectors with each other and with a power supply system onboard a vehicle, a ground circuit that, while or when complete, electrically couples the power supply system of the vehicle to a ground reference that is off-board the vehicle.

In another example, a power supply system may include an external charger that can supply electricity to a power supply system onboard a vehicle via connectors on a first lateral side or first end of the vehicle, a ground wire that may couple the power supply system with a ground reference of an off-board charging system, and a continuity jumper that can mate with and connect connectors on a second lateral side of the vehicle that is opposite the first lateral side or on a second end of the vehicle that is opposite the first end of the vehicle.

### BRIEF DESCRIPTION OF THE DRAWINGS

The subject matter may be understood from reading the following description of non-limiting embodiments, with reference to the attached drawings, wherein below:

FIG. 1 illustrates one example of a vehicle charging system and an off-board charging system or circuit of the vehicle charging system;

FIGS. 2A-N illustrate one example of a power supply system of the vehicle shown in FIG. 1;

FIG. 3 illustrates one example of a propulsion portion of the power supply system shown in FIGS. 2A-N;

FIG. 4 illustrates one example of a mixture portion of the power supply system that includes another propulsion portion of the power supply system and an auxiliary or hotel portion of the power supply system shown in FIGS. 2A-N;

FIG. 5 illustrates one example of the off-board charging portion of the power supply system;

FIG. 6 illustrates one example of a ground or grounding circuit for the external charging system and/or the power supply system;

FIG. 7 illustrates a perspective view of one example of a connector shown in FIGS. 5 and 6;

FIG. 8 illustrates a perspective view of another example of a connector shown in FIGS. 5 and 6;

FIG. 9 illustrates one example of an end view of the connector shown in FIG. 7; and

FIG. 10 illustrates one example of a conductivity circuit that connects the off-board charging system with the power supply system via the connectors.

### DETAILED DESCRIPTION

Embodiments of the subject matter described herein relate to a system and method that control charging of energy storage devices of vehicle systems. While one or more embodiments are described in connection with a rail vehicle system, not all embodiments are limited to rail vehicle systems. Unless expressly disclaimed or stated otherwise, the subject matter described herein extends to other types of vehicle systems, such as automobiles, trucks (with or without trailers), buses, marine vessels, aircraft, mining vehicles, agricultural vehicles, or other off-highway vehicles. The vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers) or logically coupled but not mechanically coupled. For example, vehicles may be logically but not mechanically coupled when the separate vehicles communicate with each other to coordinate movements of the vehicles with each other so that the vehicles travel together (e.g., as a convoy).

With respect to energy sources that can provide electric energy (e.g., direct and/or alternating current) to one or more loads, the energy sources may include one or more fuel cells. Suitable fuel cells may include a solid oxide fuel cell (SOFC), a proton exchange membrane (PEM) fuel cell, an alkaline fuel cell, direct methanol, fuel cell, molten carbonate fuel cell, and an acid fuel cell. Suitable acid fuel cells may include solid acid and phosphoric acid fuel cells. Examples of suitable fuel cell electrodes may include a catalyst containing platinum and ruthenium; or a catalyst containing titanium tungsten oxide nanoparticles that are coated with a layer of platinum. A suitable polymer membrane may be Nafion, which is commercially available from Du Pont, or expanded porous polytetrafluoroethylene (ePTFE).

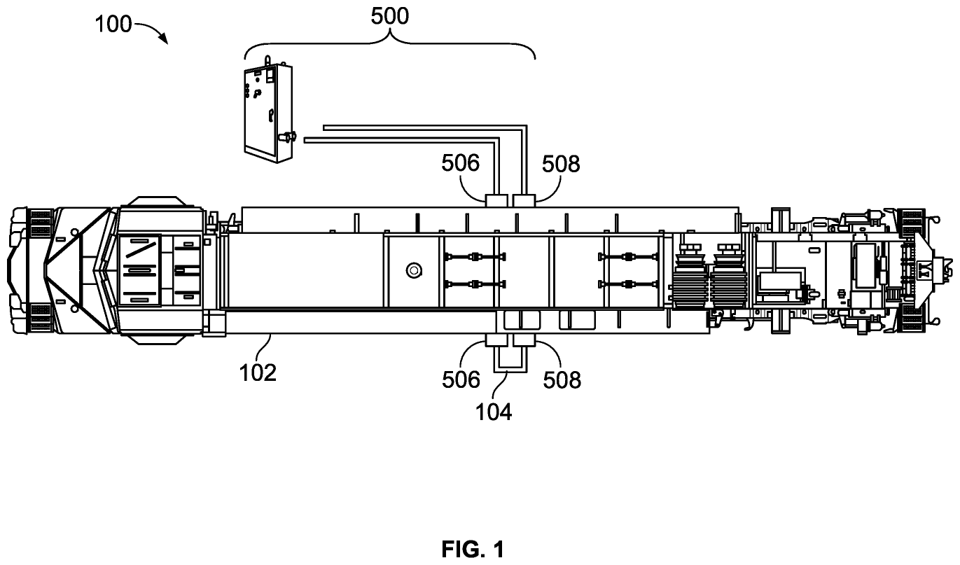

FIG. 1 illustrates one example of a vehicle charging system 100 and an off-board charging system or circuit 500 of the vehicle charging system. The charging system is shown as providing electric energy (e.g., electric potential, electric current, electric power, etc.) to a vehicle 102 (e.g., a rail vehicle, such as a locomotive). Optionally, the charging system can provide electric energy to another type of vehicle, such as an automobile, a truck, a mining vehicle, an agricultural vehicle, or the like. This energy can be used to charge energy storage devices onboard the vehicle and/or can be used to directly power loads of the vehicle (e.g., without first storing the energy in an energy storage device). The energy storage devices can represent battery cells, battery modules, battery strings, capacitors, supercapacitors, etc. The energy that is stored can be used to power one or more loads. The loads can include propulsion loads such as traction motors or auxiliary loads such as heating, ventilation, and air conditioning (HVAC) systems. Parts of the charging system may be off-board the vehicle and other portions may be onboard the vehicle.

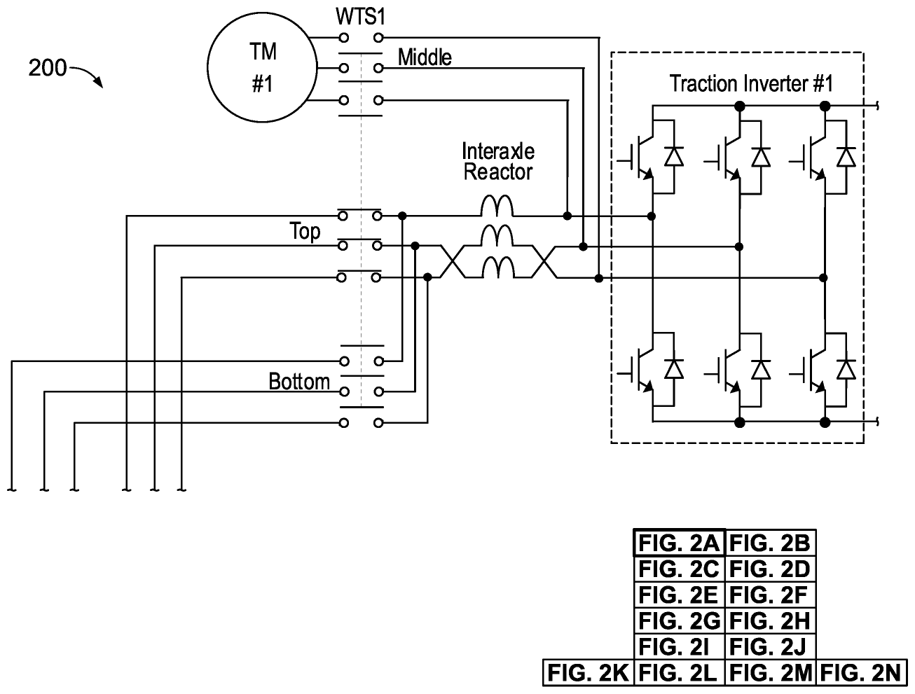

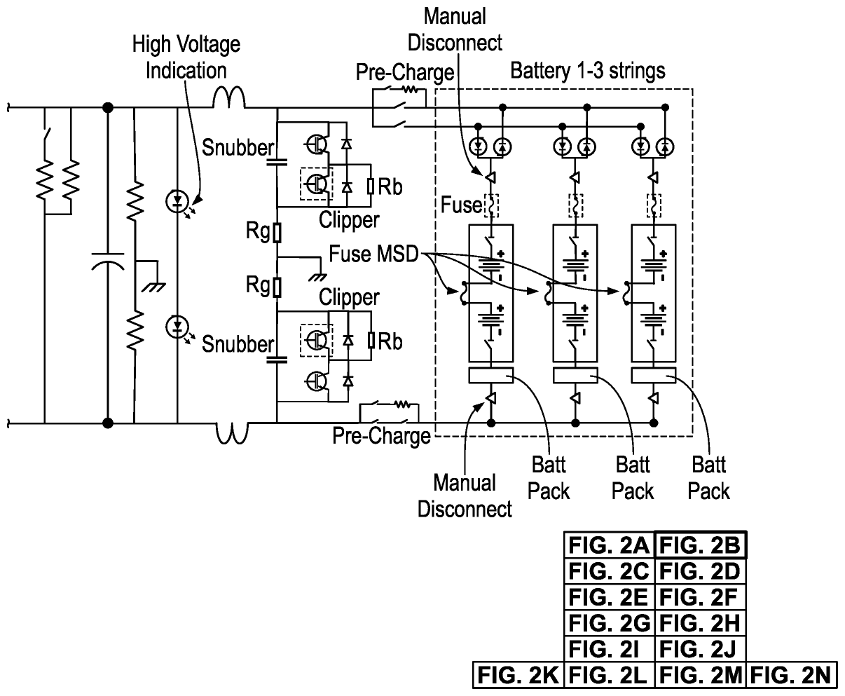

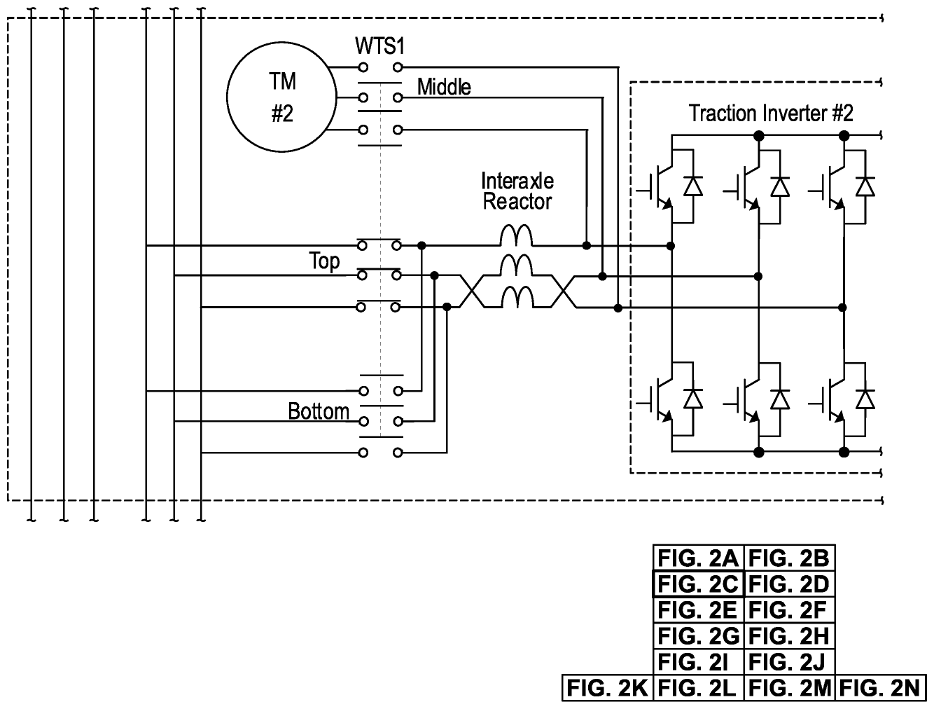

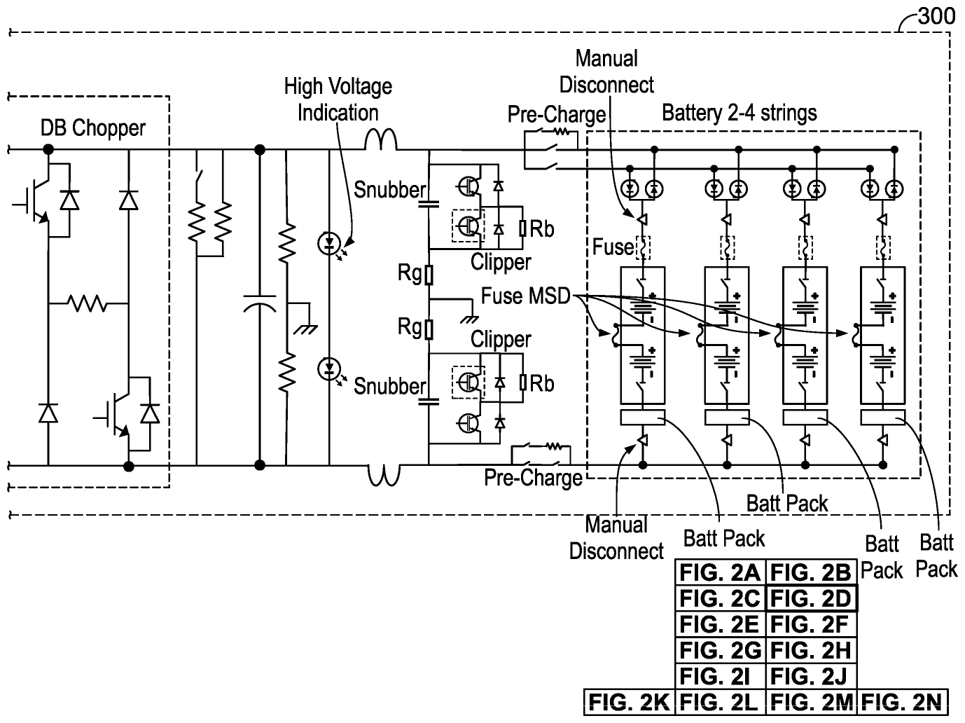

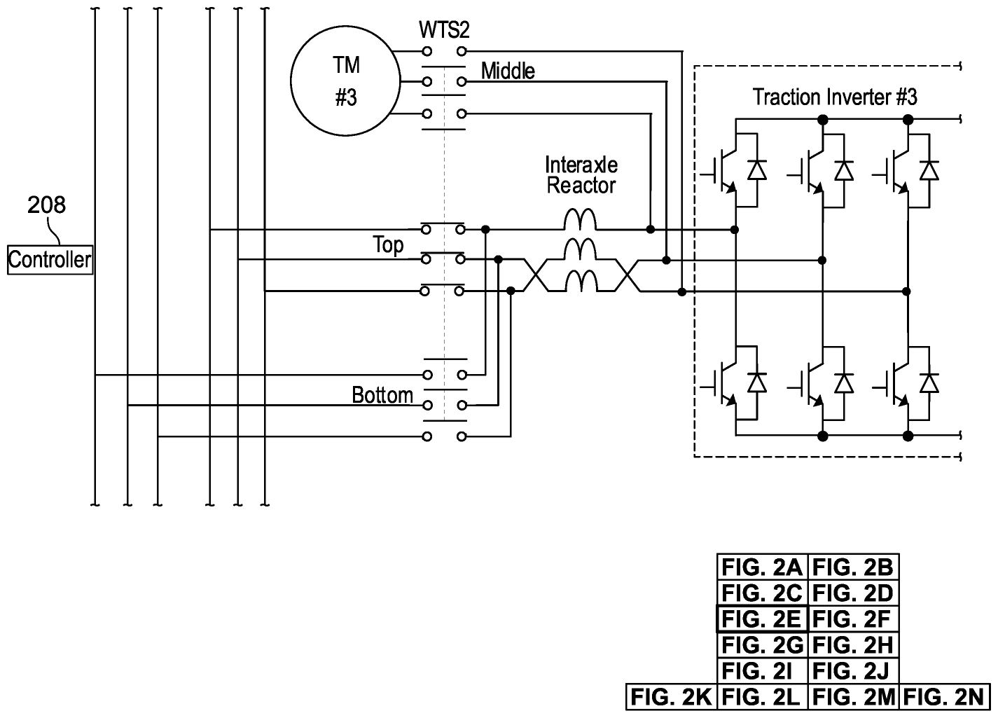

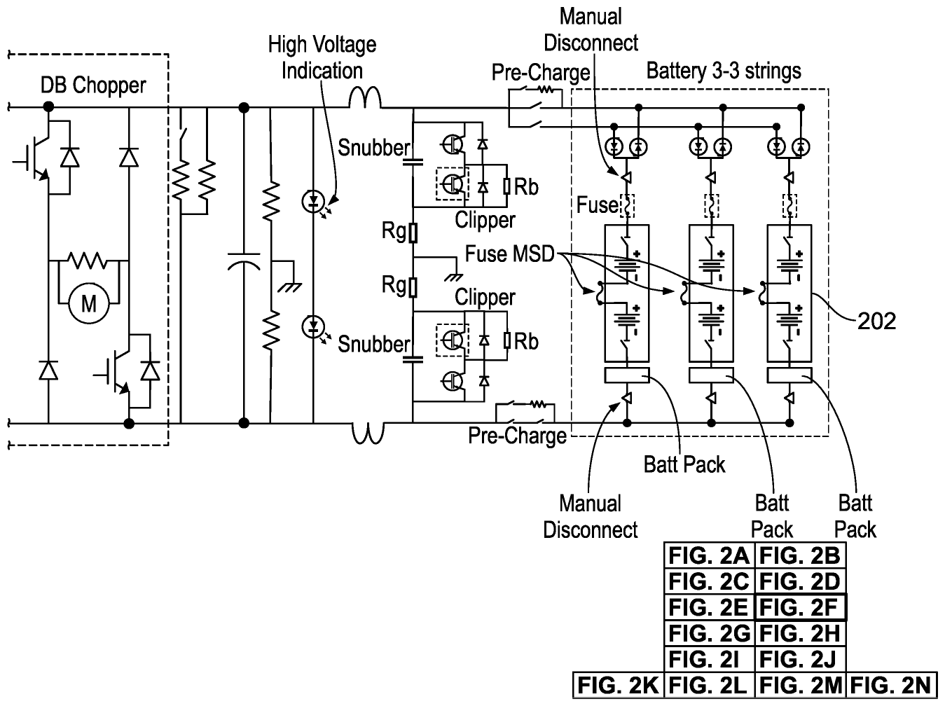

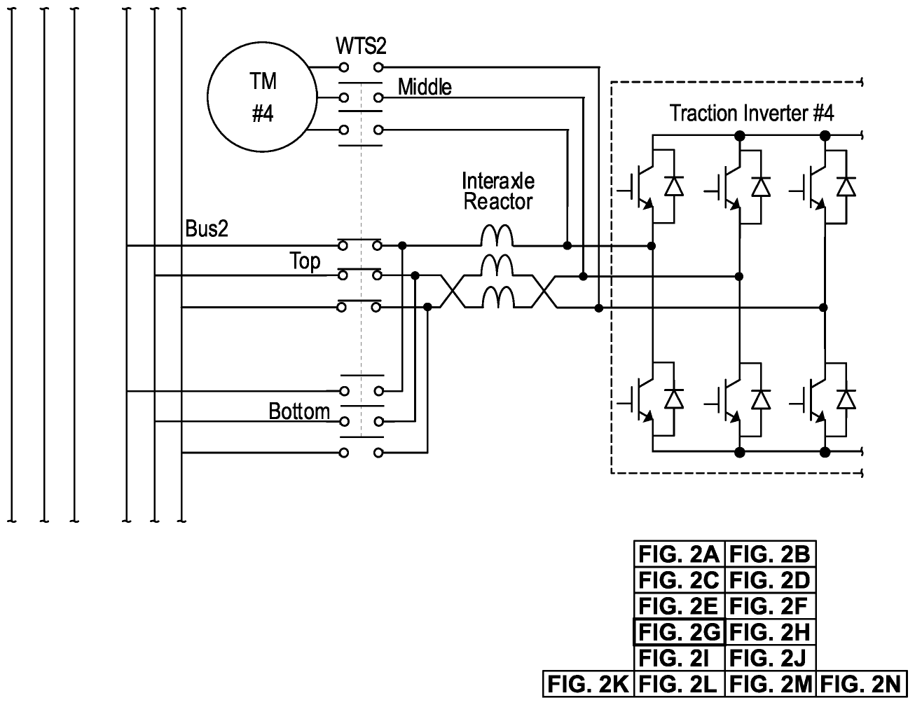

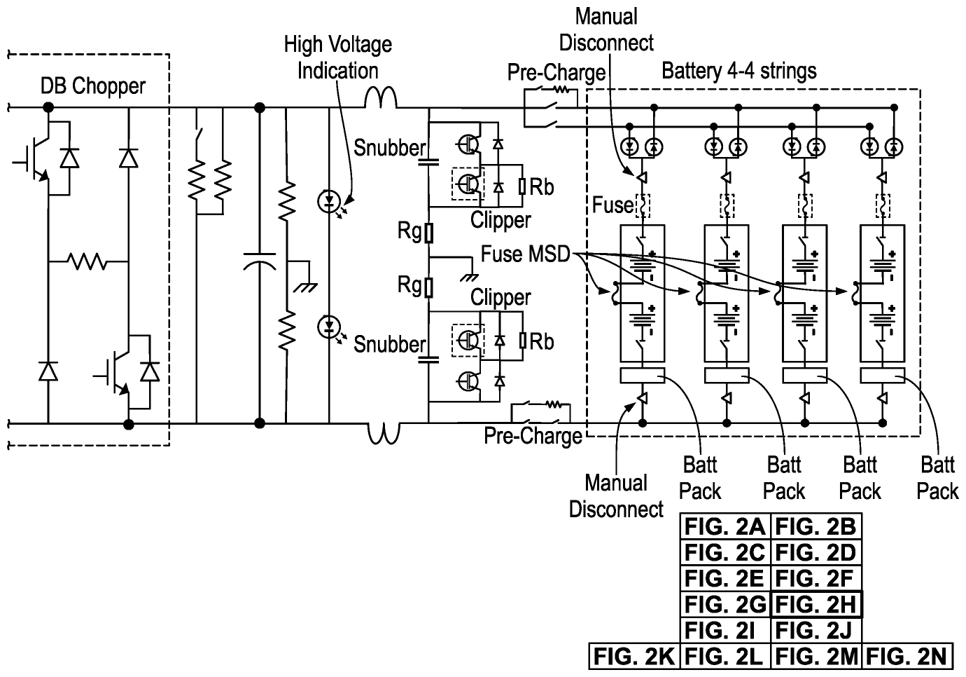

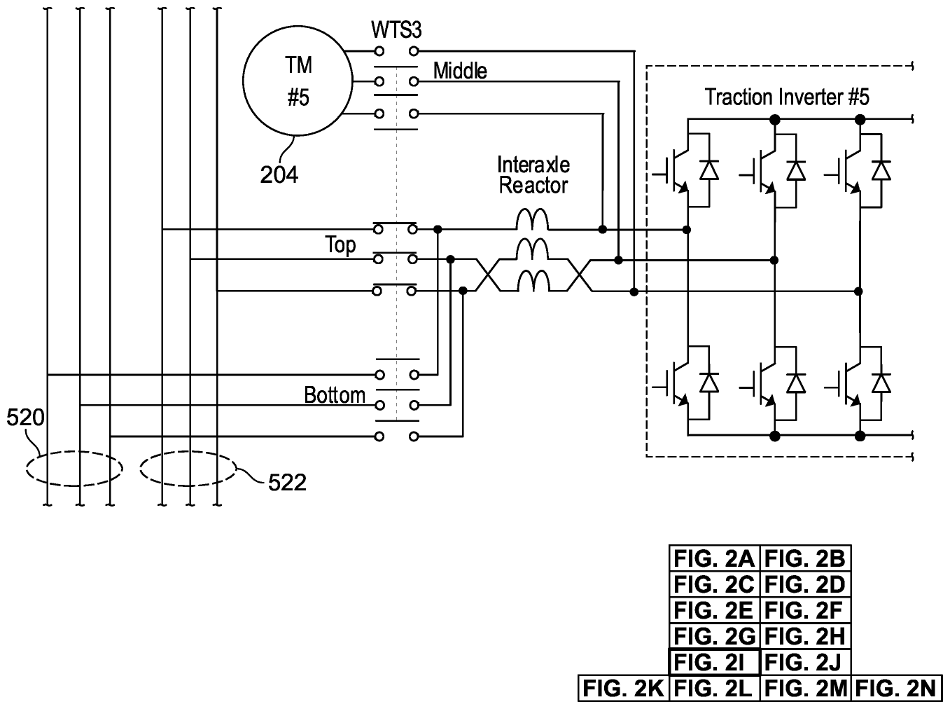

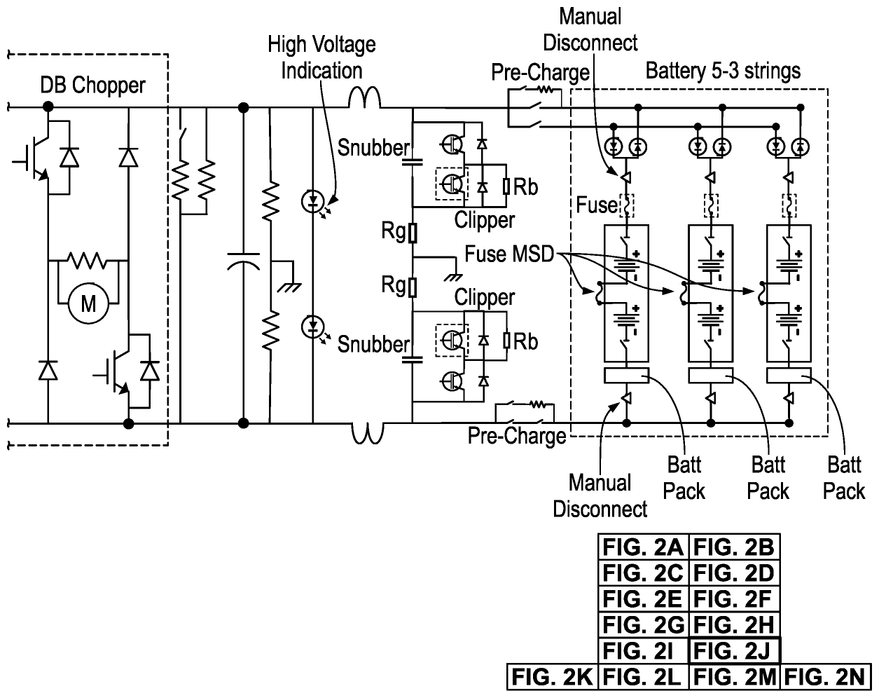

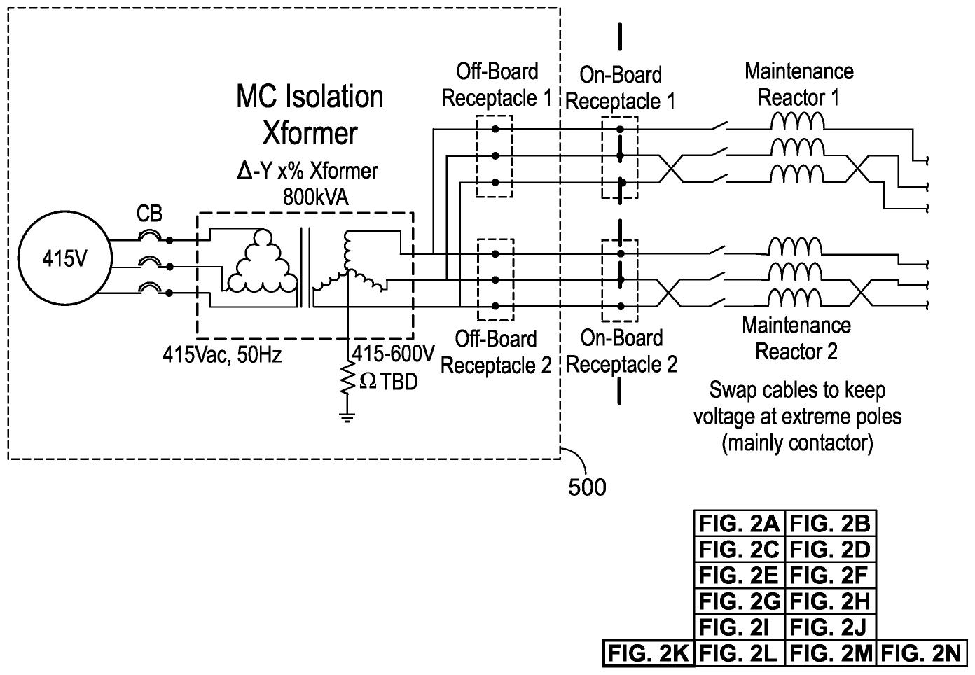

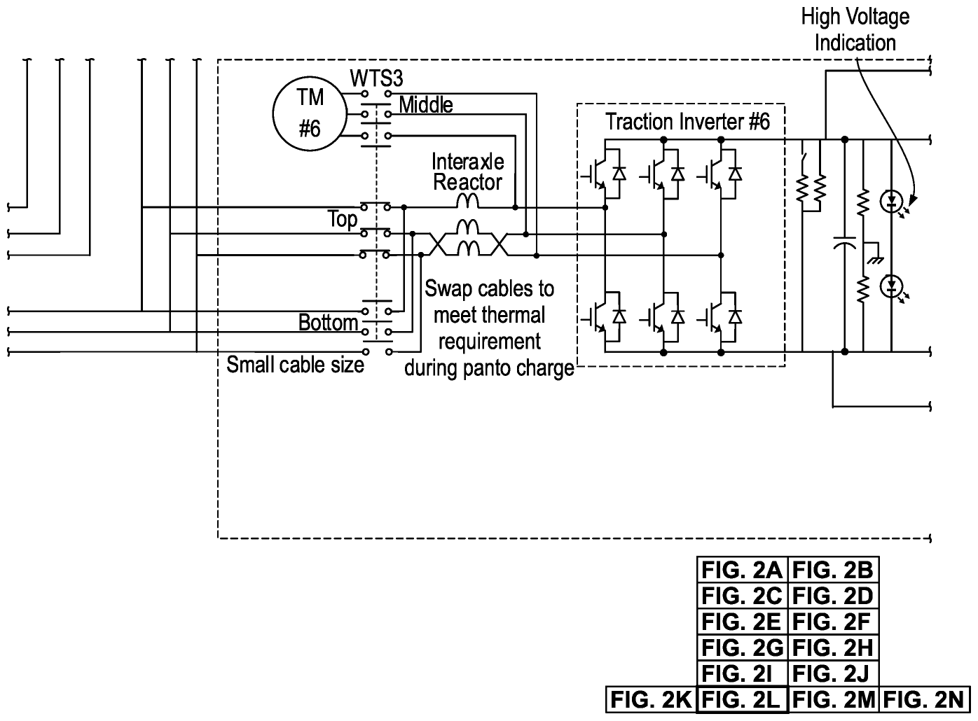

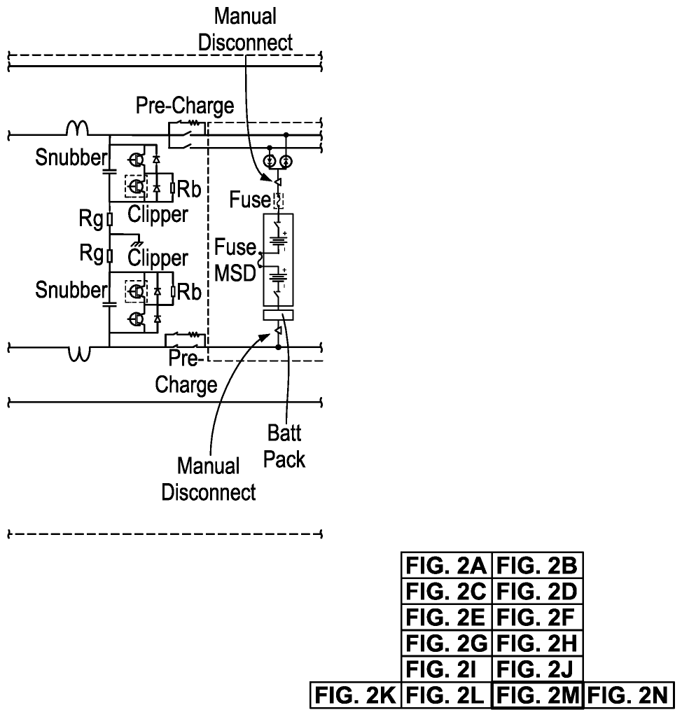

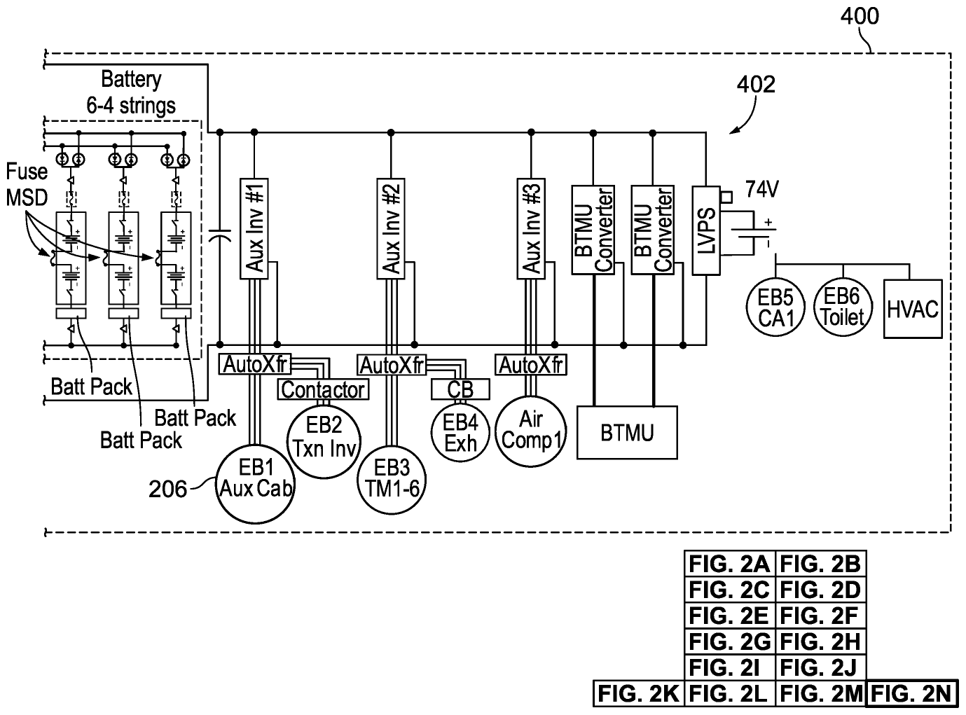

With continued reference to the charging system shown in FIG. 1, FIGS. 2A-N illustrate one example of a power supply system 200 of the vehicle shown in FIG. 1. The power supply system may control conduction of electric energy from off-board the vehicle (e.g., via the charging system) to energy storage devices 202 and/or loads 204, 206 (including propulsion loads, such as motors, and auxiliary loads, such as HVAC systems, air blowers, compressors, starter battery chargers, hotel power sources, passenger cars, operator cab amenities, etc.). The power supply system includes circuitry partially formed by conductive pathways 210 that are onboard the vehicle (which can be referred to as onboard conductive pathways). These onboard conductive pathways can be formed or arranged into multiple groups or sets 520, 522, such as two or more groups or sets. In one example, each of these groups or sets may conduct different portions of voltage that is conducted to the energy storage devices for charging the energy storage devices and/or receiving voltage from the energy storage devices. Each of these groups or sets also can conduct different portions (e.g., phases) of alternating current that is conducted between the components of the power supply system. The power supply system can control conduction of the electric energy (e.g., voltage, or direct current, and/or alternating current) between these components (e.g., for powering the loads using the energy storage devices, for load balancing between the energy storage devices, etc.) via the onboard conductive pathways.

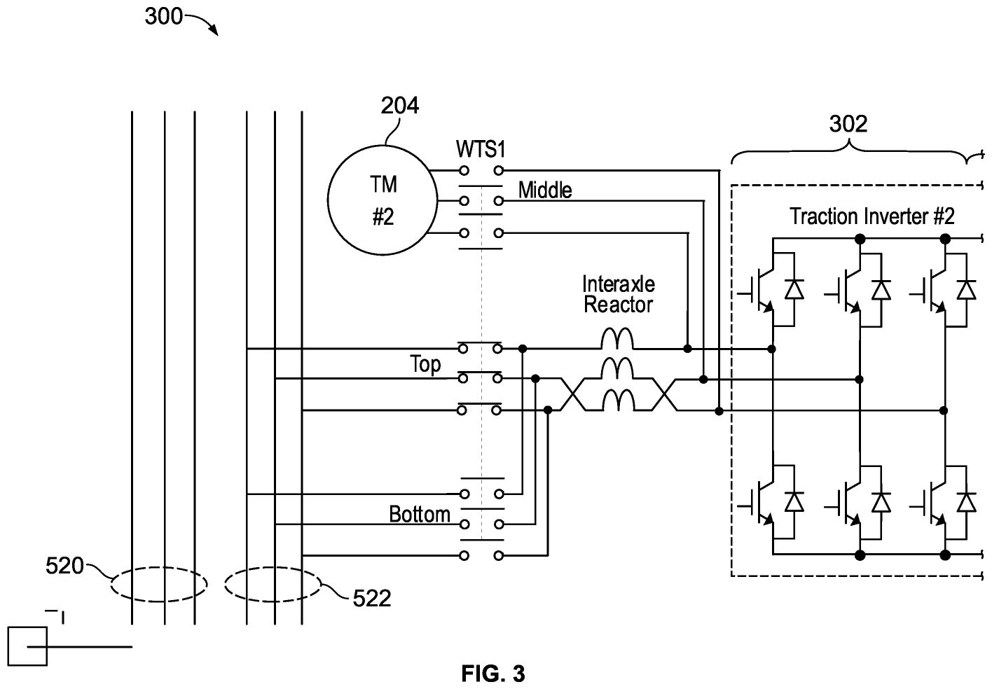

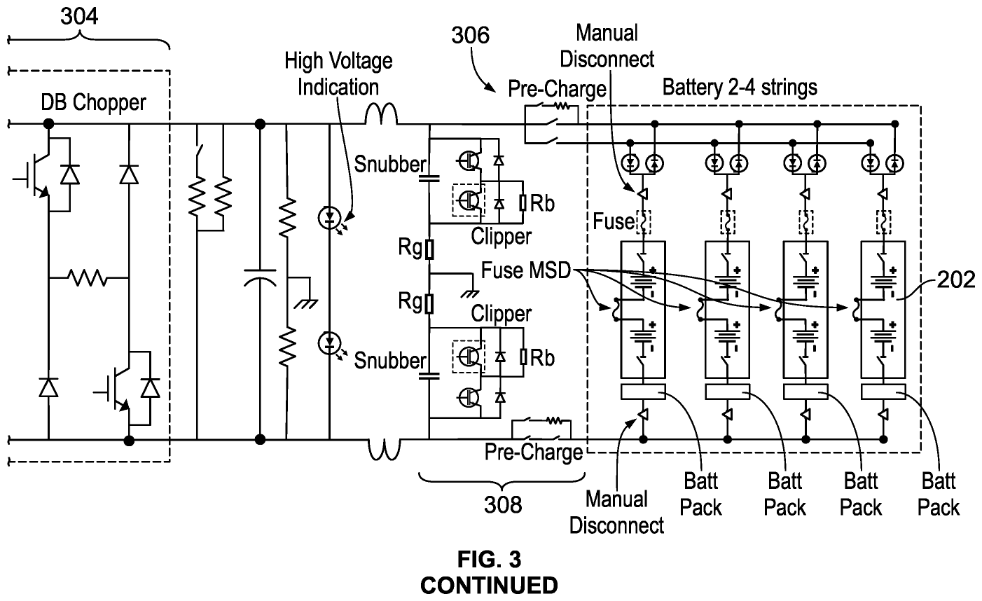

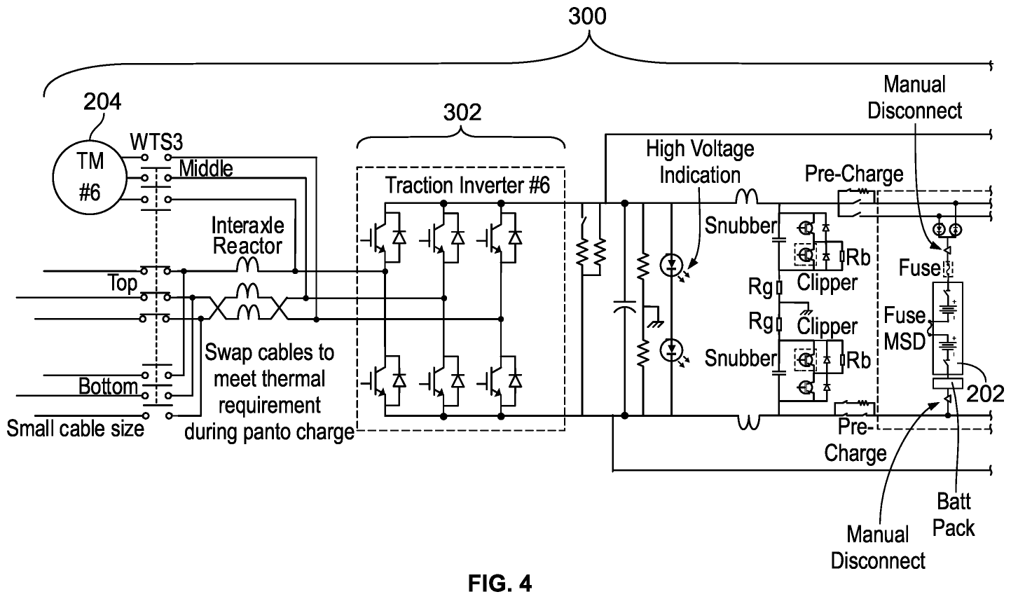

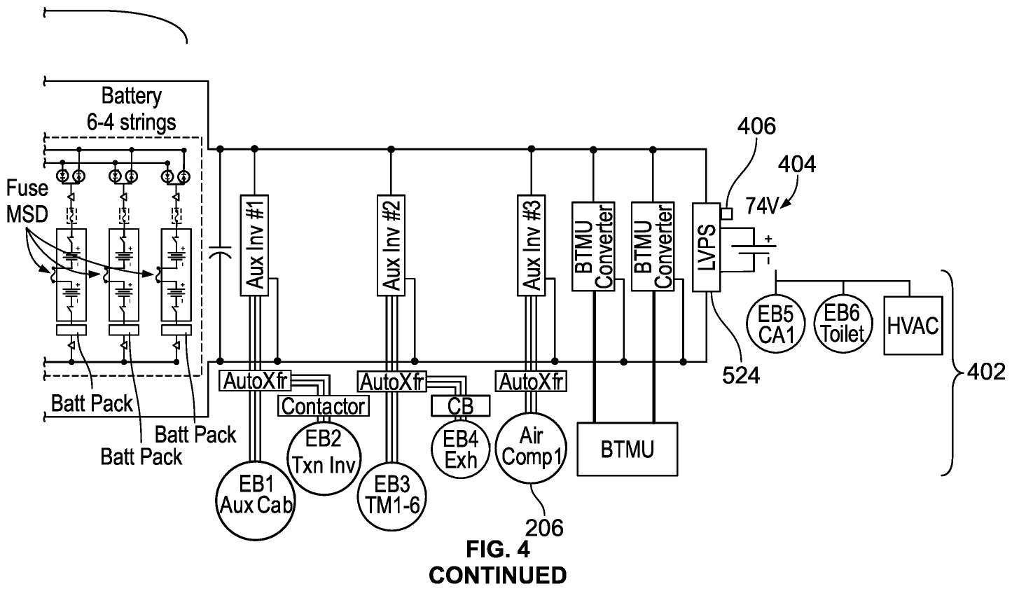

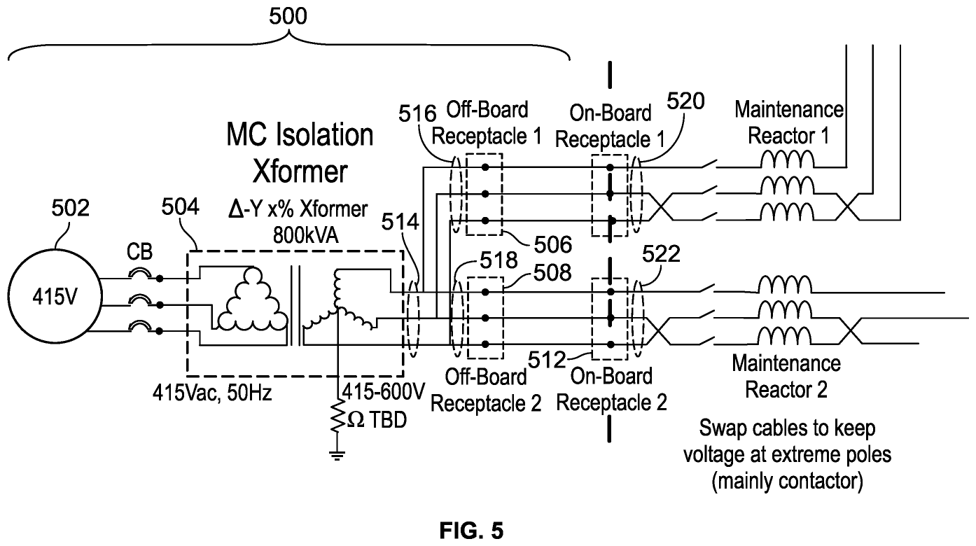

FIG. 3 illustrates one example of a propulsion portion 300 of the power supply system shown in FIGS. 2A-N, FIG. 4 illustrates one example of a mixture portion 400 of the power supply system that includes another propulsion portion of the power supply system and an auxiliary or hotel portion 402 of the power supply system shown in FIGS. 2A-N, and FIG. 5 illustrates one example of the off-board charging portion of the power supply system. The power supply system optionally can be referred to as a power supply circuit, the propulsion portion may be referred to as a propulsion circuit, the mixture portion can be referred to as a mixture circuit, the auxiliary or hotel portion may be referred to as an auxiliary or hotel circuit, and the off-board charging portion may be referred to as an off-board charging circuit. The illustrated power supply circuit may include six propulsion circuits and one auxiliary or hotel circuit, and other embodiments may include a different number of propulsion circuits and/or auxiliary circuits.

The propulsion circuits can include the propulsion loads, such as traction motors that rotate wheels to move the vehicle, connected to the energy sources by one or more propulsion power converter switch(es) 302, chopper(s) 304, contactor(s) 306, protective circuit(s) 308 for the energy storage devices, and the like. The contactors connect or disconnect the energy sources with the propulsion load, and the choppers and inverters modify the energy from the energy sources, such as by converting the voltage from the battery cells to a multi-phase alternating current.

The mixture circuit can have the propulsion circuit and the auxiliary or hotel circuit connected with each other, as shown in FIG. 4. The auxiliary circuit can include an energy source 404. The energy source in the auxiliary circuit may be a lower power or lower energy source than each of the energy sources of the propulsion circuits. For example, the auxiliary circuit may be rated at a lower voltage or energy level than the propulsion circuit. The auxiliary energy source may include one or more battery cells providing up to about seventy-five (75) volts that may include and/or be connected to a starter battery. This starter battery or auxiliary energy source may provide lower voltage or energy than the propulsion energy sources and may be used to power one or more of the auxiliary or hotel loads. The starter battery or auxiliary energy source may be used to start an engine or other components of the vehicle requiring less energy or electric power than the propulsion loads.

The propulsion circuit (both the one included in the mixture circuit and the additional propulsion circuits shown in FIGS. 2A-N) may be rated at a higher voltage or energy level than the auxiliary circuit. The energy sources in the propulsion circuit may include one or more battery cells providing higher voltage, such as about eight hundred volts to about fifteen hundred volts (direct current) to power the propulsion loads. The propulsion circuit and the auxiliary circuit are conductively coupled with each other. This can allow for the off-board charging system to charge both the energy sources of the propulsion and auxiliary circuits.

For example, as shown in FIG. 5, the off-board charging system may have a power source 502. This power source may be an external power source to the vehicle and may represent a connection to the utility grid, one or more generators, one or more alternators, one or more energy sources (e.g., batteries or fuel cells), another vehicle or vehicle system (e.g., another locomotive), a direct current power plant, and the like. The external power source may provide lower energy to the propulsion and auxiliary circuits, such as about four hundred eighty volts at sixty hertz (or another voltage and/or frequency, such as four hundred fifteen volts). The external power source may include an off-board power converter 504 having one or more internal transformers between the external power source and the external connectors that mate with onboard connectors 510, 512 of the vehicle system to conductively couple the external power source with the propulsion and auxiliary circuits.

There may be several (e.g., three) conductive pathways 524 extending from the external power source to the internal transformer and at least a first set or group 514 of the conductive pathways may be connected with and extending from the internal transformer. This first set or group may split into at least second and third sets or groups 516, 518 of the conductive pathways. In this way, the number of conductive pathways (e.g., wires, cables, or the like) extending or coming from the external power source and transformer may increase (e.g., be doubled or more) as shown in FIG. 5. For example, the transformer may have the first set or group of conductive pathways formed from three buses, wires, or cables carrying different portions of the energy (e.g., different phases of the alternating current, different portions of a single phase alternating current, different portions of direct current, etc., or the like, provided to the transformer by the external power source. Optionally, this first group may include more or fewer buses, wires, or cables. These buses, wires, or cables may each split into the multiple (e.g., two or more) second and third sets or groups. Each of these sets or groups (e.g., each group of the second group and the third group) can be connected with conductive contacts (e.g., pins, conductive receptacles, plugs, plates, or the line) in one of off-board connectors 506, 508 (also shown in FIG. 1). The off-board connectors may represent the contacts, connections between the conductive pathways and the contacts, non-conductive or insulative housings (e.g., plastic outer shells), or the like, to enable the off-board connectors to mate with the corresponding onboard connectors that are onboard or coupled with the vehicle. The onboard connectors can include corresponding contacts that can mate with the contacts in the off-board connectors so that the off-board charging system is conductively coupled with the power supply system onboard the vehicle. In one example, each of the onboard connectors is conductively coupled with a different onboard set or group 520 or 522 of the conductive pathways of the power supply system onboard the vehicle. Each of the onboard sets or groups can be formed from multiple (e.g., three) buses, wires, cables, or the like (e.g., for separate conduction of three phases of alternating current in each onboard group). Optionally, the number of conductive connections may be more than a single pair of the cables or connectors. As described above, the energy provided from the off-board source can be alternating current with various frequencies and/or phases (or single phase), direct current, etc. While not shown, other suitable connectors may include a pantograph, a third rail, and the like. In one embodiment, the controller can selectively route power from two or more connectors (e.g., a pantograph and a plug-in connector) that may be more power than just one connector may provide.

As shown in FIGS. 2 through 4, at least one of the onboard groups or sets of the conductive pathways can feed or otherwise conduct electric current from the off-board charging system to the propulsion portions of the onboard power supply system. At least one other of the onboard sets or groups of the conductive pathways can feed or otherwise conduct electric current from the off-board charging system to both the propulsion portions and the mixture portion of the onboard power supply system. For example, this other onboard conductive pathway group may split into more conductive pathways (e.g., wires, cables, etc.) between the off-board charging system and the mixture portion of the power supply system. The conductive pathways of the onboard conductive pathway group split so that half of these conductive pathways are connected with and supply current to the mixture portion of the power supply system and the other half of these conductive pathways re-connect with the conductive pathways of the group to connect with the propulsion portions of the power supply system. This splitting and reconnecting of the onboard conductive pathways connected to the off-board conductive pathways can cause more electric power to be supplied to the propulsion portions of the power supply system and less electric power to be supplied to the mixture portion of the power supply system. This can allow for the energy storage devices of the propulsion portions to be charged faster and with more power than the energy storage devices of the mixture portion. As described above, the mixture portion of the power supply system may be rated (or capable of handling) up to a lower limit on voltage (e.g., seventy-five volts) while the propulsion portions of the power supply system may be rated up to a higher limit on voltage (e.g., four hundred eighty volts). This can allow for more voltage to be supplied to the propulsion portions than the mixture portion.

The off-board charging system may include the power converter that can convert the alternating current received from the off-board power source to direct current (direct current) that is conducted to the power supply system via the connectors. This power converter can include one or more transformers that can change the incoming alternating current having a relatively lower voltage (e.g., less than one hundred volts) to an outgoing direct current having a relatively higher voltage (e.g., at least one thousand volts) due to the number of conductive windings in the transformer. While this larger direct current may be useful to charge the higher voltage energy storage devices of the propulsion portions of the power supply system, this direct current may be too large to safely conduct to the lower voltage energy storage device 404 of the mixture portion of the power supply system.

To avoid damaging the lower voltage energy storage device (also referred to as an auxiliary energy storage device), the mixture portion may include another power converter 524 (referred to as an auxiliary power converter). The auxiliary power converter may include or represent a low or lower voltage power supply that can selectively connect or disconnect the auxiliary energy storage device with the direct current bus of the mixture portion of the power supply system. The auxiliary power converter can be controlled by a controller 208 (shown in FIGS. 2A-N) of the power supply system, which can represent one or more processors that perform the operations described herein.

The controller can act automatically on its own volition based on sensor input and/or be responsive to operator input. The controller can communicate with components of the power supply system to control operation of the components. For example, the controller can direct the auxiliary power converter to selectively supply power. The power may be supplied to the auxiliary energy storage device while the direct current bus is charged (e.g., conducting direct current) from the off-board charging system and a state of charge of the auxiliary energy storage device is below a determined or designated threshold state of charge. This can help ensure that the auxiliary energy storage device is sufficiently charged for one or more basic functions, such as starting an engine of the vehicle or powering a hotel load. The controller may provide power to the aux batteries at a different c-rate than to the propulsion batteries. This may be based at least in part on battery temperatures, states-of-charge, battery health, a desire to extend battery life, a desire to quick charge and reduce wait time, an availability of power, and the like. In one example, if the supplied power, such as from a utility grid, is less than a maximum c-rate of the propulsion batteries, the aux batteries may be charged at their maximum c-rate and the propulsion batteries may be supplied with the rest of the available power, which in this example is less than the full capability of the propulsion battery. In another example, if there is a desire for fastest charging of the propulsion battery and the supplied power is less than the maximum capability of the propulsion batter, the controller may selectively route power from the aux batteries to the propulsion batteries to enable a faster charge.

The controller optionally can control the auxiliary power converter to supply voltage to the auxiliary energy storage device while the direct current bus of the mixture portion is charged, and a temperature of the auxiliary energy storage device is cooler than a determined or designated threshold temperature. This can help with shortening the time needed to charge the auxiliary energy storage device (as hotter batteries may charge at slower rates) and/or increasing the useful life of the auxiliary energy storage device. The auxiliary power converter may include a temperature sensor 406 or an additional temperature sensor 406 may be placed at or near the auxiliary energy storage device to measure and communicate temperatures of the auxiliary energy storage device to the controller. Optionally, the power supply system may include several mixture portions, or several auxiliary energy storage devices and several auxiliary power converters. The controller can selectively control operation of these auxiliary power converters to independently control which auxiliary energy storage devices are charged at any given time. For example, the controller can select which of the auxiliary energy storage devices are charged based on states of charge of the auxiliary energy storage devices, temperatures of the auxiliary energy storage devices, C-ratings of the auxiliary energy storage devices, or states of health of the auxiliary energy storage devices.

Each of the propulsion portions of the power supply system may include a propulsion power converter. In one embodiment, the propulsion power converter may be disposed between the inverters/choppers and the energy storage devices of the propulsion portions. The propulsion power converter may include or represent a high or higher voltage power supply that can selectively connect or disconnect the energy storage devices of the propulsion portions with the direct current bus of the propulsion portions of the power supply system. The propulsion power converters can be controlled by the controller of the power supply system.

The controller can direct the propulsion power converters to supply voltage to the propulsion energy storage device while the direct current bus of the corresponding propulsion portion is charged from the off-board charging system and/or one or more energy storage devices and a state of charge of the propulsion energy storage device is below a determined or designated threshold state of charge. This can help ensure that the propulsion energy storage device is sufficiently charged for one or more basic functions, such as propulsion running the cooling system, head end power, operator cab equipment, charging a control battery, other auxiliary functions, starting an engine of the vehicle (e.g., for a hybrid vehicle, such as a hybrid locomotive or automobile), etc.

The controller optionally can control the propulsion power converter to supply voltage to the propulsion energy storage device while the direct current bus of the propulsion portion is charged, and a temperature of the propulsion energy storage device is cooler than a determined or designated threshold temperature. This can help with shortening the time needed to charge the propulsion energy storage device (as hotter batteries may charge at slower rates) and/or increasing the useful life of the propulsion energy storage device. The propulsion power converter may include a temperature sensor, or an additional temperature sensor may be placed at or near the propulsion energy storage devices to measure and communicate temperatures of the propulsion energy storage devices to the controller.

The controller can selectively control operation of these propulsion power converters to independently control which propulsion energy storage devices are charged at any given time. For example, the controller can select which of the propulsion energy storage devices are charged based on states of charge of the propulsion energy storage devices, temperatures of the propulsion energy storage devices, C-ratings of the propulsion energy storage devices, or states of health of the propulsion energy storage devices.

The controller can coordinate operation of the propulsion and/or auxiliary power converters to charge the propulsion and/or auxiliary energy storage devices at the same time or different times. The controller can select a subset of these energy storage devices and coordinate operation of the propulsion and/or auxiliary power converters to charge the propulsion and/or auxiliary energy storage devices in the subset, while other energy storage devices are not charged. As described above, the splitting of the pathways from the off-board charging system may increase (e.g., double, or nearly double subject to intrinsic or inherent losses in the system) the total amount of alternating current supplied to the power converter(s).

The auxiliary power converter can supply alternating current to one or more of the auxiliary loads and, if there is excess alternating current (the alternating current output by the power converter exceeds the alternating current demanded by the auxiliary load(s)), the excess alternating current is conducted by the circuit to the energy source of the auxiliary circuit to charge (e.g., trickle charge) the auxiliary energy source. If there still is excess alternating current above and beyond the alternating current demanded by the auxiliary load(s) and the alternating current used to charge the auxiliary energy source, this remaining excess alternating current can be conducted by the circuit(s) to one or more of the propulsion energy sources to charge the propulsion energy source(s). For example, the remaining excess alternating current can be changed to direct current by the propulsion power converters for charging the propulsion energy source(s).

The inverter in each of the propulsion portions of the power supply system can convert the alternating current conducted to the propulsion portions from the external charging system to a direct current for conduction of the direct current on the bus to the propulsion energy sources. This single inverter in each propulsion portion of the power supply system increase the voltage, or upvolt, the alternating current that is received and convert this alternating current into a higher voltage direct current for conduction to the energy sources of the propulsion portion. This increased voltage direct current can be used to charge the energy sources of the propulsion portion. In one example, the inverter can increase the voltage to a high voltage (e.g., 1500 volts) or another value based on application specific parameters.

As described above, the conductive pathways from the off-board or external charging system may split into two or more off-board sets or groups of conductive pathways. These off-board sets of conductive pathways can be conductively coupled with two or more onboard sets or groups of conductive pathways by way of connectors that mate with each other. In one example, the vehicle charging system may include a continuity circuit formed from additional conductive pathways that form a closed loop circuit extending through the external or off-board charging system, the conductive pathways, the off-board connectors, the onboard connectors, and the power supply system onboard the vehicle. This continuity circuit may be used to ensure that the conductive pathways carrying or conducting electric power for charging the energy storage devices or powering the loads are safely connected in a closed loop circuit. For example, control signals may be communicated through or along the continuity circuit. If the control signals are conducted through the continuity circuit (e.g., from the off-board charging system to the controller or the off-board charging system both sends and receives the signal), then this can indicate that the off-board and onboard connectors are connected with each other, and the circuit is complete. This can be a valuable safety check to ensure that voltages or currents being conducted between the off-board charging system and the power supply system do not pose a safety risk to personnel.

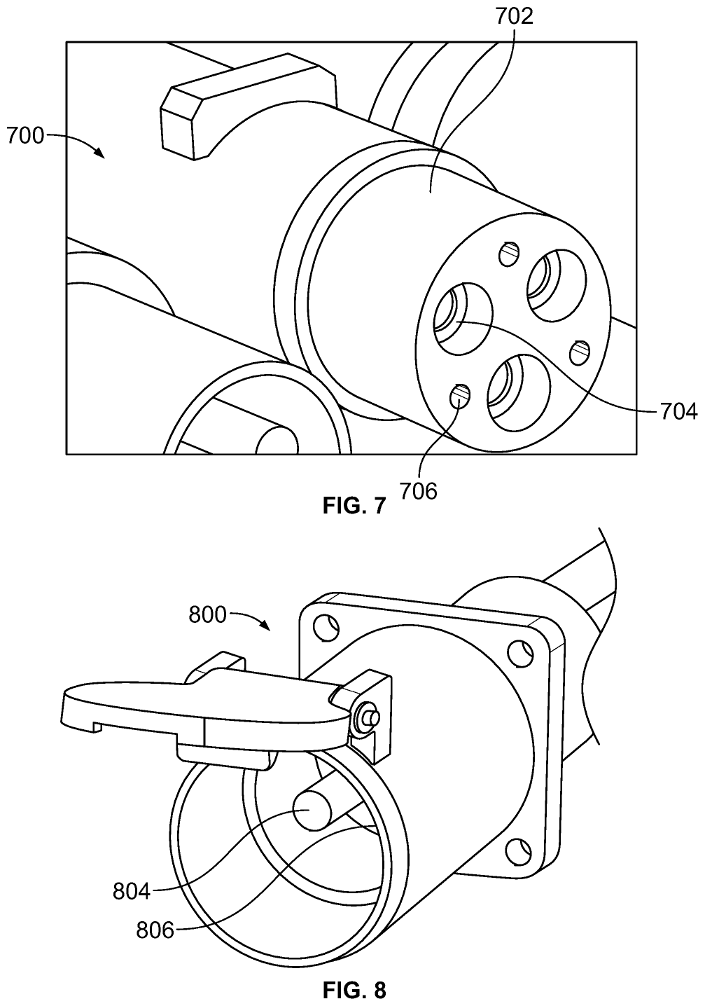

FIGS. 7 and 8 illustrate perspective views of examples of connectors 700, 800. FIG. 9 illustrates one example of an end view of the connector shown in FIG. 7. The connector 700 can represent at least one of the onboard or off-board connectors 506, 508, 618, 620, and the connector 800 can represent the other of the onboard or off-board connectors 506, 508, 618, 620. The connector 700 can be referred to as a female connector as the connector 700 includes a dielectric or insulative housing 702 with receptacles 704, 706 that include conductive contacts 900, 902 (shown in FIG. 9). These conductive contacts can be conductive plates, walls, linings, or the like, within the receptacles. The receptacles receive contacts 804, 806 of the other connector 800. The connector 800 can be referred to as a male connector as the connector 800 includes a dielectric or insulative housing 802 with the conductive contacts 804, 806 that are received into the receptacles of the female connector for conductively coupling (e.g., mating) the contacts with each other. The contacts are, in turn, conductively coupled with conductive pathways described herein.

Each of the connectors can include three contacts 804, 900 for carrying voltage or current for charging the energy storage devices, for powering loads of the power supply system, and/or for transferring voltage or current to the off-board charging system (e.g., for returning this voltage or current to a utility grid or another vehicle). For example, in FIG. 9, the contacts 900 within the larger receptacles 704 can be conductively coupled with the conductive pathways that conduct voltage or current between the off-board charging system and the power supply system for charging energy storage devices and/or powering loads. These contacts may conduct different portions of the voltage or different phases of the current. The three contacts 900 in the larger receptacles may be, for example, connected with the three conductive pathways in the group 516 or the group 518 of conductive pathways shown in FIG. 5, with the three larger male contacts 804 in the male connector connected with the three conductive pathways in the group 520 or the group 522 of conductive pathways shown in FIG. 5. Conversely, the three contacts 900 in the larger receptacles may be, for example, connected with the three conductive pathways in the group 520 or the group 522 of conductive pathways shown in FIG. 5, with the three larger male contacts 804 in the male connector connected with the three conductive pathways in the group 516 or the group 518 of conductive pathways shown in FIG. 5. While the illustrated example relates to three contacts in the connectors and three conductive pathways in each group, alternatively, each connector and/or group may include a single contact or conductive pathway, two contacts or conductive pathways, or more than three contacts or conductive pathways for conducting the voltage or current for charging the energy storage devices and/or powering loads.

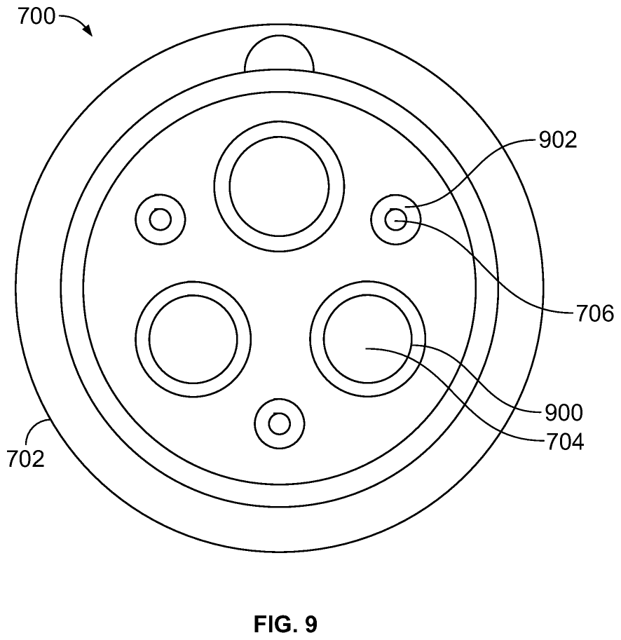

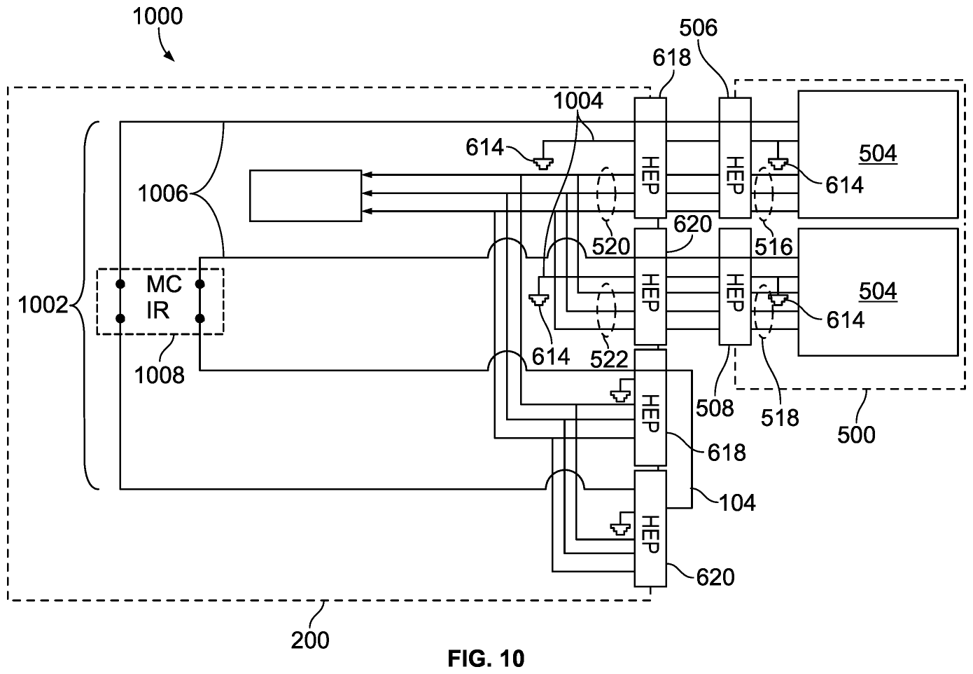

FIG. 10 illustrates one example of a conductivity circuit 1000 that connects the off-board charging system with the power supply system via the connectors. The off-board charging system may include multiple power converters as shown in FIG. 10. As described above, the groups of the conductive pathways extending from the off-board charging system are connected with the groups of the conductive pathways of the power supply system via the contacts 804, 900 in the mated connectors. The other contacts 806, 902 of the connectors may not conduct voltage or current for powering loads or charging energy storage devices. In the illustrated example, at least one of these other contacts may be conductively coupled with ground references 614 by additional conductive pathways 1004 and at least one of these other contacts may be conductively coupled with a conductivity circuit 1002. The conductivity circuit may include conductive pathways 1006 extending from the off-board charging system to the connectors coupled with this charging system, extending from the connectors coupled with the power supply system or vehicle, and/or conductive pathways extending to the controller.

The conductive pathways forming the conductivity circuit can extend to an interruption relay 1008. This interruption relay can be or include one or more switches, contactors, relays, etc., that can open to interrupt or open the conductivity circuit. The off-board charging system can conduct a low voltage (e.g., lower than the voltage conducted from the off-board charging system to the power supply system for charging the energy storage devices or powering the loads, such as twenty-four volts) through the conductive pathways of the continuity circuit. The controller of the power supply system and/or the off-board charging system can include one or more processors that monitor this voltage conducted in or through the continuity circuit. If the processors detect that the voltage is not being conducted, this can indicate that there is some opening or interruption in the continuity circuit. This also can indicate a fault (e.g., opening, short circuit, etc.) in the conductive pathways and/or power supply circuit that are charging the energy storage devices and/or powering the loads. Responsive to detecting this interruption, the processors can open the interruption relay. This can stop the off-board charging system from conducting voltage or current to the power supply system and/or the power supply system from conducting voltage or current to the off-board charging system. For example, opening the interruption relay can open the continuity circuit. Upon detecting that the continuity circuit is open, the off-board charging system can stop conducting voltage or current to the power supply system via the connectors.

As shown in FIG. 1, the vehicle may include two or more sets or pairs of the connectors. For example, one set or pair of connectors may be on a first lateral side of the vehicle, a front end of the vehicle, a second lateral side of the vehicle that is opposite the first lateral side, or a rear end of the vehicle that is opposite the front end. Another set or pair of connectors may be on the same side or end of the vehicle. To ensure that the continuity circuit is completed and not open, the connectors in one set or pair may need a jumper connection 104. This jumper connection optionally can be referred to as a pig tail and can include or represent at least one conductive pathway that conductively couples the contacts that are in the connectors joined by the jumper connection and that are coupled with the continuity circuit. This can complete the continuity circuit and prevent the gap or open portion between these connectors from opening the continuity circuit.

Optionally, the external or off-board charging system may include only a single connector. The continuity circuit with a single connector can be provided by a conductive pathway coupled with one of the contacts that does not conduct voltage or current for charging energy storage devices or powering loads. This conductive pathway can extend through a mating connector onboard the vehicle, through the interruption relay 1008, and then return to the same single connector of the external charging system (but be connected with another contact that that does not conduct voltage or current for charging energy storage devices or powering loads).

The multiple connectors onboard the vehicle can allow for easier charging of the energy sources onboard the vehicle by the external charging system as the vehicle can be charged regardless of which direction the vehicle is facing.

But during charging of the energy sources using the external charging system, the additional set of connectors that are not coupled with the external charging system may be connected to each other using the pigtail or jumper connection to avoid introducing a break or opening in the continuity circuit. For example, the connectors that are not being used for connecting directly to the external charging system may be conductively connected with each other by the jumper connection to maintain the continuity circuit or keep the continuity circuit closed. This can provide a continuous conductive circuit that allows the loads, components, and energy sources to be powered by the external charging system.

Optionally, the additional connectors may be used to increase the power directed into the power supply system. For example, one set or pair of the connectors may be connected with one external charging system and another set or pair of the connectors may be connected with another external charging system (or the same external charging system). This can increase the alternating current directed into the power supply system, such as by doubling or nearly doubling the alternating current relative to only connecting one of the two sets of connectors to the external charging system. The connectors may be used to supply alternating current power to external loads, such as in the case of an emergency, during maintenance of the vehicle, for transferring energy to other vehicles, for transferring energy to a utility grid, etc. The different sets or pairs of the connectors may be disposed on the same lateral side or end of the vehicle, on opposite lateral sides of the vehicle, on opposite ends of the vehicle, or on one lateral side and one end of the vehicle.

In another example, the connectors on one side or end of the vehicle may be connected to the external charging system, and the connectors on the opposite side of the vehicle may be connected with the connectors on one side or end of another vehicle. For example, multiple vehicles may be stationed side-by-side with the external charging system to one side of one of the vehicles. The external charging system may be connected with the connectors on a first side of a first vehicle, the connectors on an opposite, second side of the first vehicle may be connected (e.g., via cables, wires, etc.) with the connectors on the first side of a second vehicle, the connectors on the second side of the second vehicle may be connected with each other or with the connectors on the first side of a third vehicle, and so on. This can allow for multiple power supply systems that are onboard multiple vehicles to be charged simultaneously or concurrently by the same external charging system.

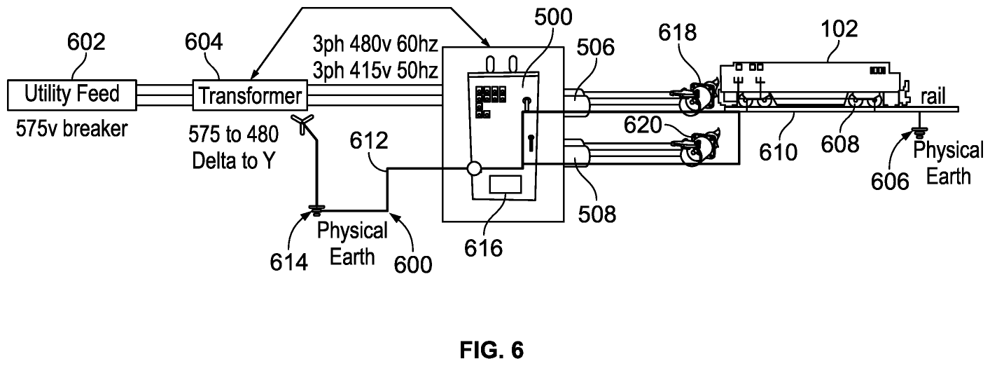

FIG. 6 illustrates one example of a ground or grounding circuit 600 for the external charging system and/or the power supply system. The external charging system may be connected to a power source 602, such as a utility feed, a utility grid, one or more fuel cells, one or more energy storage devices, one or more other vehicles (e.g., the power supply systems of the other vehicles), or another source or store of electric energy. A transformer 604 between this power source and the external charging system can step up or step down the power from the utility feed or grid, before it is supplied to the off-board or external charging system. The connectors 506, 508 of the vehicle can connect with connectors 618, 620 of the external charging system to couple the power supply system onboard the vehicle with the power source via the external charging system.

The vehicle may be conductively coupled with a first ground reference 606 for safe operation of the components in the power supply system. In one example, this first ground reference may be provided by conductive wheels 608 of the vehicle contacting a conductive portion of a route 610 (e.g., rails of a track), which in turn may be conductively coupled with the first ground reference. With respect to vehicles that do not have conductive wheels or that do not move on a conductive route, the first ground reference may be a chassis of the vehicle.

But the connection to this first ground reference may not always be secure and present. For example, corrosion on the route and/or wheels, breaks in the conductive portion(s) of the route, or the like, can interrupt or break the connection to this first ground reference (e.g., connection to earth). The grounding circuit may include one or more conductive pathways 612 that conductively couple the internal circuitry of the external charging system with a second ground reference 614 (e.g., a connection to the earth). When or while the power supply system onboard the vehicle is conductively coupled with the external charging system via the connectors, the power supply system is connected with the second ground reference by the grounding circuit. This can provide a backup, redundant, or additional connection to the ground to ensure continued, safe operation of the external charging system and the power supply system.

Returning to the description of the conductive pathways that connect the external charging system with the power supply system of the vehicle, in one example, the different conductive pathways in each of the groups may be used for various purposes. Each group of the conductive pathways may include three pathways (for a total of six pathways coming into the vehicle from the external or off-board charging system). A first pathway may conduct a first phase of alternating current, a second pathway may conduct a different, second phase of the alternating current, a third pathway may conduct a different, third phase of the alternating current, a fourth pathway may be used for communication between the external charging system and the controller of the vehicle (e.g., for connection to a trainline or other communication pathway of the vehicle), a fifth pathway may be used to connect the power supply system with the second ground reference, and a sixth pathway may be used to provide a second, additional, redundant, or backup connection of the power supply system to the second ground reference. This can help ensure that the power supply system remains connected with the ground reference for safety purposes. Optionally, the fifth and sixth conductive pathways may be used for other purposes, such as additional communication pathways between the external charging system and the power supply system, power delivery for preconditioning of the energy storage devices, load balancing of the energy storage devices, or the like.

The external or off-board charging system may include a controller 616, which can represent one or more processors that perform the operations described herein. The controller can control conduction of alternating current to the power supply system via the connectors. For example, the controller can monitor states of charge of the energy storage devices onboard the vehicle and limit or stop conduction of alternating current once the states of charge reach a determined threshold state of charge. Optionally, the controller can vary the amount of alternating current conducted to the power supply system based on financial costs of the alternating current. For example, power from the utility feed or grid may cost different amounts during different time periods. The controller of the external charging system can limit or stop conduction from the utility grid or feed during time periods when costs are elevated and continue or begin conduction from the utility grid or feed during other time periods when the costs are lower. In one embodiment, instead of the controller of the off-board charging system performing some or all these operations, the controller of the power supply system onboard the vehicle can perform some or all these operations. This can allow the power supply system to continue monitoring and controlling conduction of alternating current to the power supply system from the off-board sources as the vehicle moves to different locations (instead of relying on several different controllers at several different external charging systems).

The controller of the external charging system and/or the controller of the power supply system can control the inverters and/or converters of the power supply system to direct the alternating current or direct current to different energy storage devices at different times. For example, instead of charging the propulsion energy storage devices and the auxiliary energy storage device at the same time, the controller(s) can control the inverters and/or converters to direct the alternating current or direct current to charge the propulsion energy storage devices first, and then the auxiliary energy storage device. This can allow for the propulsion energy storage devices to be charged first before charging the auxiliary energy storage device.

Different external charging systems may supply alternating current to the power supply system at different frequencies. The inverters in the propulsion portions of the power supply system can accept the different frequencies of alternating current and convert the alternating current to direct current for charging the propulsion energy storage devices. This can allow the inverters to handle a variety of alternating current frequencies, thereby making the power supply system frequency agnostic for receipt of charging alternating current. Optionally, different external charging systems may provide different types of energy, such as one may provide alternating current while another provides direct current. The power supply system can accept either direct current or alternating current from the external charging systems. Additionally, the inverters of the power supply system can accept single phase alternating current or multi-phase alternating current from the external charging systems.

A method of supplying power to a power supply system onboard a vehicle may include receiving electricity from an off-board or external charging system, where the electricity is received by a first circuit rated at a lower voltage (e.g., about 75V) and can provide electricity to one or both of a starter battery and an auxiliary or hotel load onboard the vehicle. The electricity also is received by a second circuit rated at a larger voltage (e.g., about 480V, about 800V, or about 1500V) and can provide the electricity to a propulsion battery capable of powering one or more traction motors of the vehicle.

The electricity can be provided to a circuit that supplies alternating current through a power converter and direct current to a battery. The power converter can convert the alternating current to direct current. In one embodiment, the alternating current can be at a voltage that is less than 100V and the direct current can be at a voltage that is greater than 1000V. The electricity can be provided to a circuit that supplies alternating current through the power converter and direct current to a direct current bus and to a first battery. The direct current bus can selectively supply the direct current to a second battery that is couplable to the direct current bus via a second power converter.

The second power converter can supply power to the second battery while the direct current bus is charged and the state of charge of the second battery is below a determined state of charge threshold. The second power converter can be controlled to supply power to the second battery while the direct current bus is charged, and the temperature of the second battery is below a determined temperature threshold. The second power converter can be one of a plurality of second power converters. The second battery can be one of a plurality of second batteries. Each of the second power converters can selectively provide direct current from the direct current bus to the respective battery. Each of the second power converters can be controlled to charge the second battery independently of the other second batteries. Each of the second batteries can be selectively charged based at least in part on the state of charge, temperature, C-rating, component health, a desired or designated time to charge the second battery or batteries, a peak utility rate or cost of power from a utility grid, a peak charge range, a rating of the converter(s), tradeoffs between converter performance versus auxiliary load use versus charging efficiency, relative states of charge across the system for the various axles or groups of batteries, operator input, or the like, of that second battery. In one embodiment, electrical quality and/or reliability may be used as a factor in the selection.

Each of the second power converters can be controlled to charge the corresponding second battery simultaneously with the other second batteries. Each of the second power converters can be controlled to charge the respective second battery sequentially relative to the other second batteries so that only a subset of the plurality of batteries is charged during a time period.

In one embodiment, the controllers or systems described herein may have a local data collection system deployed and may use machine learning to enable derivation-based learning outcomes. The controllers may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used making determinations, calculations, comparisons, and behavior analytics, and the like.

In one embodiment, the controllers may include a policy engine that may apply one or more policies. These policies may be based at least in part on characteristics of a given item of equipment or environment. With respect to control policies, a neural network can receive input of a number of environmental and task-related parameters. These parameters may include, for example, operational input regarding operating equipment, data from various sensors, location and/or position data, and the like. The neural network can be trained to generate an output based on these inputs, with the output representing an action or sequence of actions that the equipment or system should take to accomplish the goal of the operation. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the vehicle controller executes that plan to achieve the desired input data to mirror the predicted best outcome scenario. Additionally, the success metric may be a combination of optimized outcomes, which may be weighed relative to each other.

In one example, a power supply system can exchange electricity with a vehicle. The power supply system may include a first circuit rated at a lower first voltage that can provide the electricity to a starter battery and/or an auxiliary load onboard the vehicle. The system also can include a second circuit rated at a higher second voltage and that can provide the electricity to a propulsion battery capable of powering one or more traction motors of the vehicle.

The first circuit may supply alternating current through a power converter and direct current to the starter battery, and the power converter can convert the alternating current to direct current at a voltage that is no greater than 100 V. The second circuit can include a first power converter that may convert the alternating current to direct current for the propulsion battery with the direct current at a voltage that is greater than 800 V.

The first circuit and/or the second circuit can supply the alternating current through the first power converter and the direct current to a direct current bus and to a first battery. The direct current bus can selectively supply the direct current to a second battery that is couplable to the direct current bus via a second power converter. The second power converter can supply power to the second battery while the direct current bus is supplied with direct current and the state of charge of the second battery is below a determined state of charge threshold value.

The second power converter may supply power to the second battery while the direct current bus is supplied with direct current and the temperature of the second battery is below a determined temperature threshold value. The second power converter may be one of a plurality of second power converters, and the second battery can be one of a plurality of second batteries. Each of the second power converters may selectively provide the direct current from the direct current bus to the respective second battery.

The system also can include a controller that may selectively energize only the first circuit, only the second circuit, or both the first circuit and second circuits. Each of the second power converters can charge the respective second battery independently of the other ones of the second batteries. Each of the second batteries may be selectively charged based at least in part on one or more of a state of charge of the second battery, a temperature of the second battery, a C-rating of the second battery, and/or a health condition of the second battery.

Each of the second power converters can charge the respective second battery simultaneously with the other second batteries. Each of the second power converters may charge the respective second battery sequentially relative to the other second batteries so that only a subset of the second batteries is charged during a time period.

In another example, a power supply system may receive electricity supplied to a vehicle. The power supply system can include a first circuit and a second circuit each coupled to an alternating current (AC) bus, and a plurality of power converter and battery pairs. Each of the power converters can be coupled to the alternating current bus and may convert alternating current from the alternating current bus to direct current and to supply the direct current to the respective battery.

The alternating current can be selectively supplied by the first circuit, the second circuit, or both. The system also can include a controller that may operate each of the power converters coupled to the alternating current bus to supply the direct current to the respective battery based at least in part on one or more of a state of charge, a temperature, a C-rating, or a health of the respective battery. The controller can control the second circuit to supply the alternating current onboard a vehicle to an auxiliary load. Responsive to there being first excess alternating current, the second circuit can supply the first excess alternating current to a lower-voltage hotel load or starter battery. Responsive to there being second excess alternating current, the second circuit can supply the second excess alternating current to a power converter configured to change the second excess alternating current to direct current, to increase the direct current, and supply the direct current to a battery that can power at least one traction motor during operation of the vehicle.

In another example, a charging system may supply electricity to a vehicle. The charging system can include connectors that may mate or couple with corresponding first and second vehicle connectors, a continuity circuit that can mate or couple third and fourth vehicle connectors with each other and with a power supply system onboard a vehicle, a ground circuit that, while or when complete, electrically couples the power supply system of the vehicle to a ground reference that is off-board the vehicle.

In another example, a power supply system may include an external charger that can supply electricity to a power supply system onboard a vehicle via connectors on a first lateral side or first end of the vehicle, a ground wire that may couple the power supply system with a ground reference of an off-board charging system, and a continuity jumper that can mate with and connect connectors on a second lateral side of the vehicle that is opposite the first lateral side or on a second end of the vehicle that is opposite the first end of the vehicle.

The vehicle may be a first vehicle, and the continuity jumper can connect the connectors on the second side of the first vehicle with connectors on a first lateral side of a second vehicle.

Use of phrases such as “one or more of . . . and,” “one or more of . . . or,” “at least one of . . . and,” and “at least one of . . . or” are meant to encompass including only a single one of the items used in connection with the phrase, at least one of each one of the items used in connection with the phrase, or multiple ones of any or each of the items used in connection with the phrase. For example, “one or more of A, B, and C,” “one or more of A, B, or C,” “at least one of A, B, and C,” and “at least one of A, B, or C” each can mean (1) at least one A, (2) at least one B, (3) at least one C, (4) at least one A and at least one B, (5) at least one A, at least one B, and at least one C, (6) at least one B and at least one C, or (7) at least one A and at least one C.

As used herein, an element or step recited in the singular and preceded with the word “a” or “an” do not exclude the plural of said elements or operations, unless such exclusion is explicitly stated. Furthermore, references to “one embodiment” of the invention do not exclude the existence of additional embodiments that incorporate the recited features. Moreover, unless explicitly stated to the contrary, embodiments “comprising,” “comprises,” “including,” “includes,” “having,” or “has” an element or a plurality of elements having a particular property may include additional such elements not having that property. In the appended claims, the terms “including” and “in which” are used as the plain-English equivalents of the respective terms “comprising” and “wherein.” Moreover, in the following claims, the terms “first,” “second,” and “third,” etc. are used merely as labels, and do not impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function devoid of further structure.

This written description uses examples to disclose several embodiments of the subject matter, including the best mode, and to enable one of ordinary skill in the art to practice the embodiments of subject matter, including making and using any devices or systems and performing any incorporated methods. The patentable scope of the subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A power supply system configured to exchange electricity with a vehicle, the power supply system comprising:
a first circuit rated at a lower first voltage and configured to provide the electricity to one or both of a starter battery or an auxiliary load onboard the vehicle; and
a second circuit rated at a higher second voltage and configured to provide the electricity to a propulsion battery capable of powering one or more traction motors of the vehicle.

2. The power supply system of claim 1, wherein the first circuit is configured to supply alternating current through a power converter and direct current to the starter battery, and the power converter is configured to convert the alternating current to direct current at a voltage that is no greater than 100 V.

3. The power supply system of claim 2, wherein the second circuit includes a first power converter configured to convert the alternating current to direct current for the propulsion battery with the direct current at a voltage that is greater than 800 V.

4. The power supply system of claim 3, wherein the one or more of the first circuit or the second circuit is configured to supply the alternating current through the first power converter and the direct current to a direct current bus and to a first battery.

5. The power supply system of claim 4, wherein the direct current bus is configured to selectively supply the direct current to a second battery that is couplable to the direct current bus via a second power converter.

6. The power supply system of claim 5, wherein the second power converter is configured to supply power to the second battery while the direct current bus is supplied with direct current and a state of charge of the second battery is below a determined state of charge threshold value.

7. The power supply system of claim 5, wherein the second power converter is configured to supply power to the second battery while the direct current bus is supplied with direct current and a temperature of the second battery is below a determined temperature threshold value.

8. The power supply system of claim 5, wherein the second power converter is one of a plurality of second power converters, and the second battery is one of a plurality of second batteries and each of the second power converters is configured to selectively provide the direct current from the direct current bus to the respective second battery.

9. The power supply system of claim 1, further comprising a controller that is configured to selectively energize only the first circuit, only the second circuit, or both the first circuit and second circuits.

10. The power supply system of claim 8, wherein each of the second power converters is configured to charge the respective second battery independently of other ones of the second batteries.

11. The power supply system of claim 8, wherein each of the second batteries is configured to be selectively charged based at least in part on one or more of a state of charge of the second battery, a temperature of the second battery, a C-rating of the second battery, or a health condition of the second battery.

12. The power supply system of claim 8, wherein each of the second power converters is configured to charge the respective second battery simultaneously with the other second batteries.

13. The power supply system of claim 8, wherein each of the second power converters is configured to charge the respective second battery sequentially relative to the other second batteries so that only a subset of the second batteries is charged during a time period.

14. A power supply system configured to receive electricity supplied to a vehicle, the power supply system comprising:
a first circuit and a second circuit each coupled to an alternating current (AC) bus;
a plurality of power converter and battery pairs, with each of the power converters coupled to the alternating current bus and configured to convert alternating current from the alternating current bus to direct current (DC) and to supply the direct current to the respective battery.

15. The power supply system of claim 14, wherein the alternating current is selectively supplied by the first circuit, the second circuit, or both.

16. The power supply system of claim 14, further comprising a controller configured to operate each of the power converters coupled to the alternating current bus to supply the direct current to the respective battery based at least in part on one or more of a state of charge, a temperature, a C-rating, or a health of the respective battery.

17. The power supply system of claim 14, further comprising a controller configured to control the second circuit, wherein the second circuit is configured to supply the alternating current onboard a vehicle to an auxiliary load, and
responsive to there being first excess alternating current, the second circuit is configured to supply the first excess alternating current to a lower-voltage hotel load or starter battery, and
responsive to there being second excess alternating current, the second circuit is configured to supply the second excess alternating current to a power converter configured to change the second excess alternating current to direct current, to increase the direct current, and supply the direct current to a battery that can power at least one traction motor during operation of the vehicle.

18. A charging system configured to supply electricity to a vehicle, the charging system comprising:
connectors configured to mate or couple with corresponding first and second vehicle connectors;
a continuity circuit configured to mate or couple third and fourth vehicle connectors with each other and with a power supply system onboard a vehicle;
a ground circuit that, when complete, electrically couples the power supply system of the vehicle to a ground reference that is off-board the vehicle.

19. A system, comprising:
an external charger configured to supply electricity to a power supply system onboard a vehicle via connectors on a first lateral side or first end of the vehicle;
a ground wire configured to couple the power supply system with a ground reference of an off-board charging system; and
a continuity jumper configured to mate with and connect connectors on a second lateral side of the vehicle that is opposite the first lateral side or on a second end of the vehicle that is opposite the first end of the vehicle.

20. The system of claim 19, wherein the vehicle is a first vehicle, and the continuity jumper is configured to connect the connectors on the second side of the first vehicle with connectors on a first lateral side of a second vehicle.
